(19) United States
(12) Patent Application Publication
(10) Pub. No.: US 2025/0154993 A1
(43) Pub. Date: May 15, 2025

(54) Brake Carrier for a Disc Brake

(71) Applicant: KNORR-BREMSE Systeme fuer Nutzfahrzeuge GmbH, Muenchen (DE)

(72) Inventors: Abdelaziz Rguichi, Olching (DE); Ralf Weber, Muenchen (DE); Alexander Werth, Muenchen (DE); Zoltan Riba, Planegg (DE); Andreas Buch, Taufkirchen (DE)

(21) Appl. No.: 18/945,686

(22) Filed: Nov. 13, 2024

(30) Foreign Application Priority Data
Nov. 14, 2023 (DE) 10 2023 131 657.5

(51) Int. Cl. F16D 65/00; F16D 55/00

(52) U.S. Cl. CPC F16D 65/0056; F16D 65/0031; F16D 2055/0008

(57) ABSTRACT

A brake carrier for a disc brake of a utility vehicle has a frame-shaped basic body with two bridge struts which are aligned parallel to each other and on each of which a pad slot for receiving a brake pad is integrally formed, and respective disc-encompassing portions connecting the ends of the bridge struts to one another, wherein a cavity is provided in at least one of the two disc-encompassing portions. The cavity has at least one inlet opening for sucking in abraded material arising during braking operations. The inlet opening is open toward an interior space surrounded by the frame-shaped basic body. An outlet opening discharges the abraded material that has entered through the inlet opening.

### CROSS REFERENCE TO RELATED APPLICATION

This application claims priority under 35 U.S.C. § 119 from German Patent Application No 102023131657.5, filed Nov. 14, 2023, the entire disclosure of which is herein expressly incorporated by reference.

### BACKGROUND AND SUMMARY

The invention relates to a brake carrier for a disc brake of a utility vehicle. The invention furthermore relates to a disc brake for a utility vehicle.

Brake carriers of the type in question for disc brakes are known in a multiplicity of variants from the prior art, for example from DE 10 2021 126 787 A1.

The environmental requirements and therefore changing legal regulations will in the future involve increased requirements for avoiding fine dust. Technical solutions for disc brakes for utility vehicles that are able to minimize brake dust, in particular the fine dust content of brake dust, as far as possible and ideally prevent its emission into the environment therefore have to be developed.

Technical solutions available for this purpose are largely designed to guide and collect the brake dust from the installation space surrounding the disc brake through a filter, with or without the aid of air pressure. For this purpose, it is usually necessary to limit the surrounding installation space by installing cover plates or shielding plates around the wheel brake.

Such a solution is known, for example, in DE 10 2021 126 787 A1 mentioned above. The solution described there has been tried and tested in practice.

As before, it is basically problematic to trap the brake dust arising during braking operations by means of such encapsulations, since the conditions in the wheel arch and within a rim cause diffuse turbulence of the arising brake dust due to the relative wind.

Furthermore, a complete encapsulation by cover plates is firstly not possible and secondly not desirable because a complete encapsulation would lead to an undesired heating of the brake pads and/or of the brake disc.

It is therefore the object of the present invention to provide a brake carrier and a disc brake having such a brake carrier, with which brake dust can be substantially prevented from escaping even without an encapsulation.

The object set is achieved by a brake carrier and by a disc brake having the features of the independent claim(s).

The brake carrier according to the invention has a frame-like basic body with two bridge struts which are aligned parallel to each other and on each of which a pad slot for receiving a brake pad is integrally formed.

The brake carrier furthermore has respective disc-encompassing portions connecting the ends of the bridge struts to one another.

A cavity is provided in at least one of the two disc-encompassing portions.

This cavity has at least one inlet opening for sucking-in abraded material arising during braking operations, said inlet opening being open toward an interior space surrounded by the frame-like basic body, and an outlet opening for discharging the abraded material that has entered through the inlet opening.

By forming a cavity in the already existing brake carrier of a disc brake, extraction of brake dust can be carried out at a suitable position, namely in the region of at least one of the disc-encompassing portions, without having to mount additional cover plates or shielding plates on the disc brake.

Advantageous refinements and developments are specified in the dependent claims.

According to one advantageous embodiment variant, the cavity has precisely one inlet opening in the form of an elongate hole. This makes it possible to extract brake dust from both sides of the brake disc in a simple manner.

According to an alternative embodiment variant, the cavity has a plurality of, in particular three, inlet openings. This permits an increase in the suction speed of the air drawn into the cavity via the inlet openings.

The inlet openings are arranged along a straight line, according to an advantageous development.

According to another preferred embodiment variant, the cavity extends parallel to an underside of the disc-encompassing portion facing away from the pad slots.

According to one advantageous embodiment variant, the outlet opening is introduced into an underside of the disc-encompassing portion facing away from the pad slots. This permits simple mounting of a suction pipe onto the outlet opening.

The outlet opening is designed as a plug-in groove, according to a preferred embodiment variant. The design as a plug-in groove also permits a simple connection of a suction pipe to transfer the drawn-in brake dust into a collection container or filter located further away.

According to an alternative embodiment variant, the outlet opening is introduced into a side surface of the disc-encompassing portion facing away from a connecting region of the bridge struts, the connecting region being designed for fixing the brake carrier on a vehicle axle as part of one of the bridge struts.

The disc brake according to the invention has a brake disc, a frame-like brake carrier which engages over a subsection of the brake disc and has pad slots integrally formed on both sides of the brake disc. Brake pads having a respective back plate and a friction pad arranged on the latter are inserted into the pad slots of the brake carrier. The disc brake also has a suction device for the extraction of abraded material arising during braking operations.

The brake carrier is designed as described above. The suction device has the cavity, which is open via the at least one inlet opening toward the interior space surrounded by the frame-like basic body, in the at least one of the two disc-encompassing portions, and a suction pipe adjoining the outlet opening.

According to an advantageous embodiment variant, the suction pipe is mounted removably at the outlet opening.

According to a further advantageous embodiment variant, the disc brake has a brake caliper which engages over the brake disc and has a pad slot opening which is covered by a cover plate.

A space above the brake pads can be covered in a simple manner with such a cover plate. The cover plate prevents the air from escaping upward and keeps the relative wind away. This reduces turbulence, as a result of which a required suction power (vacuum and volume flow) for trapping the particles is reduced.

Such a cover plate can be attached to the pad retainer, secured by the latter, or fastened to brake caliper or carrier.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic isometric illustration of an embodiment variant of a brake carrier according to the invention;

FIG. 2 is a further isometric illustration of the brake carrier shown in FIG. 1 from a different perspective and with a suction pipe attached to the outlet opening;

FIG. 3 is an enlargement of a detail of the region of the brake carrier provided with the cavity according to FIG. 2 with the suction pipe removed therefrom;

FIG. 4 is an illustration corresponding to FIG. 3 of the detail of the brake carrier from FIG. 2 with blanked-out suction pipe and three inlet openings;

FIG. 5 is an illustration corresponding to FIG. 4 of a detail of a brake carrier with an inlet opening in the form of an elongate hole;

FIG. 6 is a schematic isometric illustration of a disc brake with a brake carrier installed therein according to one of FIGS. 1 to 5; and

FIG. 7 is a schematic isometric illustration of the disc brake shown in FIG. 6 with a covered pad slot opening of a brake caliper of the disc brake.

### DETAILED DESCRIPTION OF THE DRAWINGS

In the following description of the figures, terms such as top, bottom, left, right, front, rear, etc. refer exclusively to the exemplary illustration and position, chosen in the respective figures, of the brake carrier, the pad slots, the brake pads, bridge struts, disc-encompassing portion and the like. These terms are not to be understood as limiting, that is to say that these references may change as a result of different operating positions or the mirror-symmetrical design or the like.

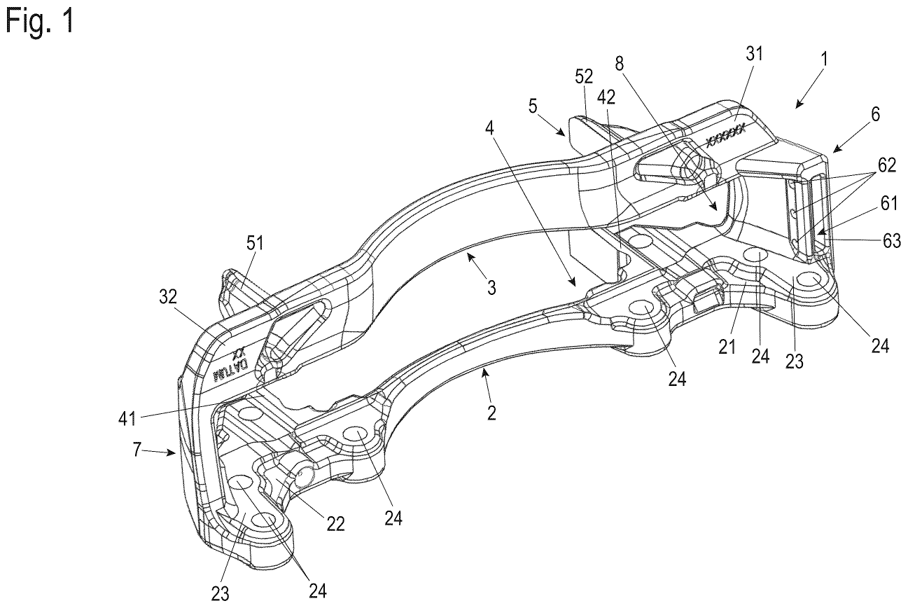

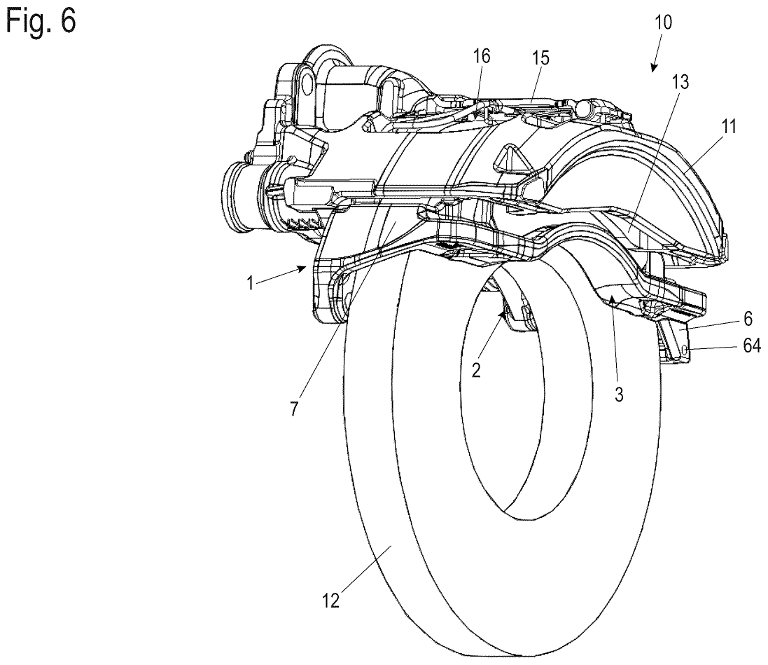

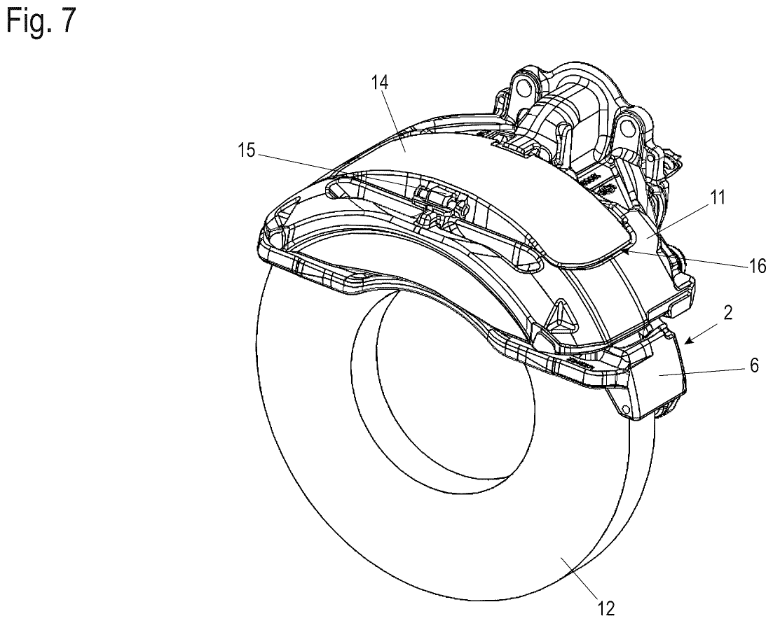

In FIG. 1, reference sign 1 is used to describe an embodiment variant of a brake carrier according to the invention for a disc brake 10 illustrated in FIGS. 6 and 7.

The disc brake 10 illustrated in FIGS. 6 and 7 furthermore has a brake caliper 11 which engages over a brake disc 12 and here is likewise frame-like. The brake caliper 11 is arranged movably here, in particular displaceably, on the brake carrier 2, which is fastenable to a limb of a vehicle axle (not illustrated here). The brake caliper 3 is preferably a sliding caliper.

The brake caliper 11 has a central pad slot opening 16 above the brake disc 12, through which brake pads 13 can be mounted and removed, in particular in order to exchange them in the event of a pad change.

The brake carrier 1 has a frame-like basic body with two bridge struts 2, 3 aligned parallel to each other. A pad slot 4, 5 is integrally formed on each of the bridge struts 2, 3 for receiving a brake pad 13.

Respective ends 21, 22, 31, 32 of the bridge struts 2, 3 are connected to each other via a respective disc-encompassing portion 6, 7.

A connection region 23 which serves for the fixing on a vehicle axle, for example by screwing to an axle flange of a vehicle axle of the utility vehicle, is integrally formed on the bridge strut 2, as can be readily seen in FIGS. 1 to 5.

The one pad slot 4 is integrally formed above the connection region 23. The other pad slot 5 is integrally formed on the second bridge strut 3.

Each of the pad slots 4, 5 is formed by a run-in-side carrier horn 41, 51, a run-out-side carrier horn 42, 52 and the bridge strut 2, 3 connecting the run-in-side carrier horn 41, 51 to the run-out-side carrier horn 42, 52.

The carrier horns 41, 42 and the bridge 2 form the application side of the brake carrier 1. Accordingly, the carrier horns 51, 52 and the bridge 3 form the reaction side of the brake carrier 1.

The brake carrier 1 is designed in such a way that it engages over a brake disc 12 illustrated in FIG. 6 of the disc brake 10.

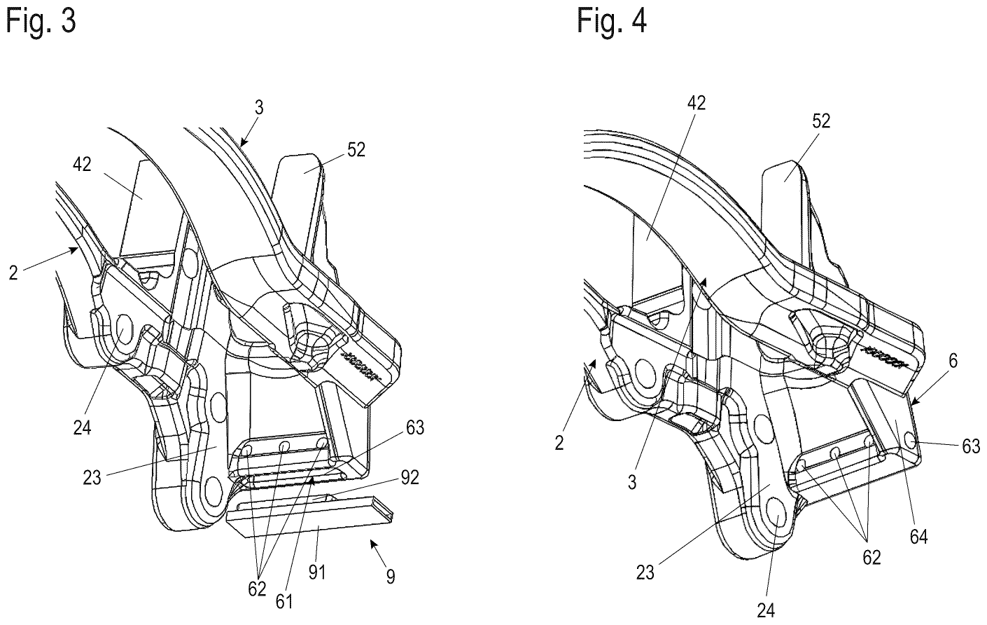

As can also be seen in FIGS. 1 and 3, a cavity 61 is provided in at least one of the two disc-encompassing portions 6, 7.

In the exemplary embodiments shown, the cavity 61 is formed in the run-out-side disc-encompassing portion 6.

The cavity 61 has at least one inlet opening 62 for sucking in abraded material arising during braking operations, said inlet opening 62 being open toward an interior space 8, which is enclosed by the inner walls of the frame-like basic body, and an outlet opening 63 for discharging the abraded material that has entered through the inlet opening 62 away from the brake carrier 1.

The interior space 8, as illustrated in FIG. 6, is substantially filled by a subsection of the brake disc 12 in the state of the brake carrier 1 installed in the disc brake.

As shown in FIGS. 1 to 4, the cavity 61 is accessible toward the interior space 8 of the brake carrier 1 via three inlet openings 62. The inlet openings 62 are preferably designed as bores. However, other forms, for example with a square or rectangular cross section, are also contemplated.

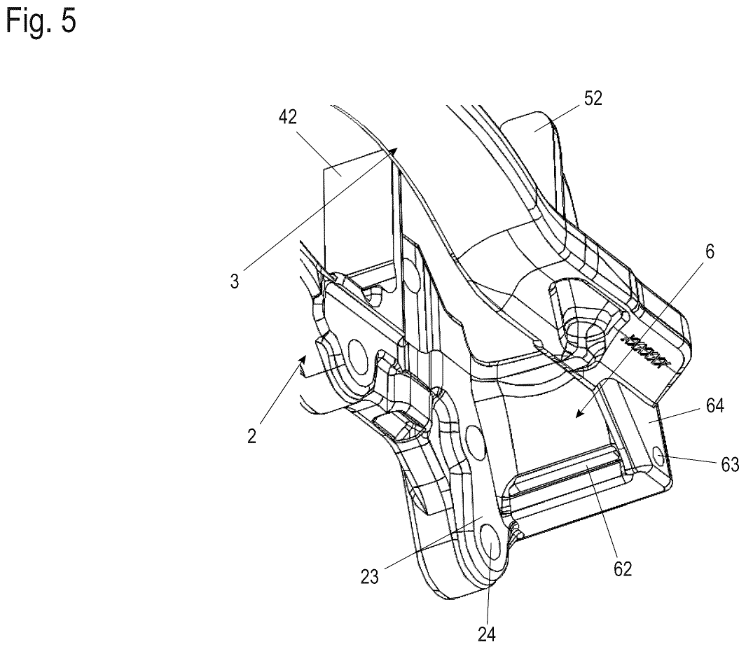

It is also contemplated, as is illustrated in FIG. 5, to provide precisely one inlet opening 62 in the form of an elongate hole or slot.

In the embodiment variant according to FIGS. 1-4 with the plurality of inlet openings 62, the latter are preferably arranged along a straight line, preferably parallel to the axis of rotation of the brake disc 12.

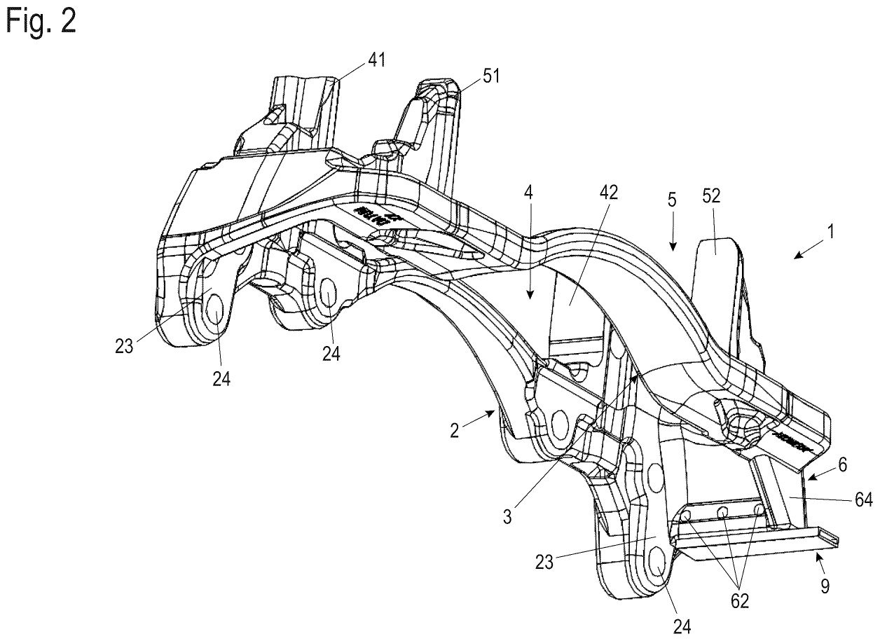

The abraded material of the friction material of the brake pads or abraded material of the brake disc 12 itself, that accumulates in the cavity 61 during operation, is guided away from the brake carrier 1 through the outlet opening 63 via a suction pipe 9, shown by way of example in FIGS. 2 and 3, preferably via a collection container (not shown here), which is provided with a filter in which the abraded material is filtered out of the air guided through the suction pipe 9.

The cavity 61 preferably extends parallel to an underside of the disc-encompassing portion 6, 7 facing away from the pad slots 4, 5.

In a preferred embodiment variant, the outlet opening 63 is introduced into an underside of the disc-encompassing portion 6 facing away from the pad slots 4, 5, as can be readily seen in FIGS. 1 and 3.

To facilitate the installation of the suction pipe 9, the outlet opening 63 is designed as a plug-in groove. The suction pipe 9 is formed accordingly with a plug-in geometry 92 which extends from a basic body 91 and can be inserted into the outlet opening 63 designed as a plug-in groove, as illustrated in FIG. 2.

Alternatively, it is also contemplated to introduce the outlet opening 63 in a side surface 64 of the disc-encompassing portion 6 facing away from the connection region 23 of the bridge strut 2, as shown in FIGS. 4 to 6.

In this embodiment variant, the outlet opening 63 is preferably designed as a bore with a circular cross section.

However, a different geometry is also possible here, for example a rectangular cross-sectional geometry of the outlet opening 63, to which a corresponding connection of a suction pipe 9 is connectable.

The suction device of the disc brake shown in FIG. 6 accordingly has the cavity 61, which is open via the at least one inlet opening 62 toward the interior space 8 surrounded by the frame-like basic body, in the at least one of the two disc-encompassing portions 6, 7, and the suction pipe 9 which is connectable to the outlet opening 63.

By providing the cavity 61 in the brake carrier 1 itself, it is possible to substantially avoid an encapsulation of the disc brake.

In the embodiment variant shown in FIG. 7, the pad slot opening 16 of the brake caliper 11 is closed by a cover plate 14 to improve the suction power (vacuum and volume flow).

The cover plate 14 can be attached, for example, to a pad holding strap 15 holding the brake pads 13 in the respective pad slot 4, 5, can be secured by said pad holding strap or fastened to brake caliper 11 or brake carrier 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Brake carrier
2 Bridge strut
21 End
22 End
23 Connection region
24 Bore
3 Bridge strut
31 End
32 End
33 Connection region
34 Bore
4 Pad slot
41 Carrier horn
42 Carrier horn
5 Pad slot
51 Carrier horn
52 Carrier horn
6 Disc-encompassing portion
61 Cavity
62 Inlet opening
63 Outlet opening
64 Side surface
7 Disc-encompassing portion
8 Interior space
9 Suction pipe
10 Disc brake
11 Brake caliper
12 Brake disc
13 Brake pad
14 Slot cover
15 Pad holding strap
16 Pad slot opening

What is claimed is:

1. A brake carrier for a disc brake of a utility vehicle, comprising:
a frame-shaped basic body comprising
(i) two bridge struts aligned parallel to each other and on each of which a pad slot for receiving a brake pad is integrally formed, and
(ii) respective disc-encompassing portions connecting ends of the two bridge struts to one another,
wherein a cavity is provided in at least one of the two disc-encompassing portions,
wherein the cavity has at least one inlet opening for sucking-in abraded material arising during braking operations, said at least one inlet opening being open toward an interior space surrounded by the frame-shaped basic body, and an outlet opening for discharging the abraded material that has entered through the at least one inlet opening.

2. The brake carrier as claimed in claim 1, wherein the cavity has precisely one inlet opening in the form of an elongate hole.

3. The brake carrier as claimed in claim 1, wherein the cavity has a plurality of inlet openings.

4. The brake carrier as claimed in claim 3, wherein the plurality of inlet openings are arranged along a straight line.

5. The brake carrier as claimed in claim 1, wherein
the cavity extends parallel to an underside of the disc-encompassing portion facing away from the pad slots.

6. The brake carrier as claimed in claim 1, wherein
the outlet opening is introduced into an underside of the disc-encompassing portion facing away from the pad slots.

7. The brake carrier as claimed in claim 1, wherein the outlet opening is in the form of a plug-in groove.

8. The brake carrier as claimed in claim 1, wherein
the outlet opening is introduced into a side surface of the disc-encompassing portion facing away from a connecting region of the bridge struts, and
the connecting region is designed for fixing the brake carrier on a vehicle axle as part of one of the bridge struts.

9. A disc brake for a utility vehicle, comprising:
a brake disc,
a frame-shaped brake carrier which engages over a subsection of the brake disc and has pad slots integrally formed on both sides of the brake disc,
brake pads which are inserted into the pad slots of the brake carrier and have a respective back plate and a friction pad arranged on the back plate,
a suction device for extracting abraded material arising during braking operations,
wherein the brake carrier comprises: a frame-shaped basic body comprising (i) two bridge struts aligned parallel to each other and on each of which a pad slot for receiving a brake pad is integrally formed, and (ii) respective disc-encompassing portions connecting ends of the two bridge struts to one another,
wherein a cavity is provided in at least one of the two disc-encompassing portions,
wherein the cavity has at least one inlet opening for sucking in abraded material arising during braking operations, said at least one inlet opening being open toward an interior space surrounded by the frame-shaped basic body, and an outlet opening for discharging the abraded material that has entered through the at least one inlet opening,
wherein the suction device comprises a suction pipe adjoining the outlet opening.

10. The disc brake as claimed in claim 9, wherein the suction pipe is mounted removably at the outlet opening.

11. The disc brake as claimed in claim 9, further comprising:
a brake caliper which engages over the brake disc and has a pad slot opening,
wherein the pad slot opening is covered by a cover plate.
